(19) United States
(12) Patent Application Publication
(10) Pub. No.: US 2019/0199144 A1
(43) Pub. Date: Jun. 27, 2019

(54) Wireless Power System With Ambient Field Nulling

(71) Applicant: Apple Inc., Cupertino, CA (US)

(72) Inventors: Jouya Jadidian, Saratoga, CA (US); Martin Schauer, Fremont, CA (US); Andro Radchenko, SAN JOSE, CA (US); Cheung-Wei Lam, San Jose, CA (US); Ketan Shringarpure, Santa Clara, CA (US); Vaneet Pathak, Los Altos, CA (US)

(21) Appl. No.: 15/980,401

(22) Filed: May 15, 2018

Related U.S. Application Data
(60) Provisional application No. 62/609,112, filed on Dec. 21, 2017.

(51) Int. Cl. H02J 50/70; H02J 7/02; H02J 50/12; H01F 38/14; H01F 27/29; H01F 27/28; H01F 27/38

(52) U.S. Cl. CPC H02J 50/70; H02J 7/025; H02J 50/12; H01F 27/38; H01F 27/29; H01F 27/2823; H01F 38/14

(57) ABSTRACT

A wireless power system uses a wireless power transmitting device to transmit wireless power to wireless power receiving devices. The wireless power transmitting device has wireless power transmitting coils that extend under a wireless charging surface. Non-power-transmitting coils and magnetic sensors may be included in the wireless power transmitting device. During wireless power transfer operations, control circuitry in the wireless power transmitting device adjusts drive signals applied to the coils to reduce ambient magnetic fields. The drive signal adjustments are made based on device type information and other information on the wireless power receiving devices and/or magnetic sensor readings from the magnetic sensors. In-phase or out-of-phase drive signals are applied to minimize ambient fields depending on device type.

This application claims the benefit of provisional patent application No. 62/609,112, filed on Dec. 21, 2017, which is hereby incorporated by reference herein in its entirety.

### FIELD

This relates generally to power systems, and, more particularly, to wireless power systems for charging electronic devices.

### BACKGROUND

In a wireless charging system, a wireless charging mat wirelessly transmits power to a portable electronic device that is placed on the mat. The portable electronic device has a receiving coil and rectifier circuitry for receiving wireless alternating-current (AC) power from a coil in the wireless charging mat that is overlapped by the receiving coil. The rectifier converts received AC power into direct-current (DC) power.

### SUMMARY

A wireless power system uses a wireless power transmitting device to transmit wireless power to wireless power receiving devices. The wireless power transmitting device has wireless power transmitting coils that extend under a wireless charging surface.

In some configurations, non-power-transmitting coils (ambient magnetic field reduction coils) and magnetic sensors may be included in the wireless power transmitting device. Adjustments to the wireless power transmitting coils and optional adjustments to the non-power-transmitting coils are used to produce nulling magnetic fields during wireless power transmission operations. Magnetic sensors gather optional magnetic field measurements for feedback.

During wireless power transfer operations, control circuitry in the wireless power transmitting device adjusts drive signal phase and/or magnitude as drive signals are applied to the wireless power transmitting coils and non-power-transmitting coils to reduce ambient magnetic fields. The drive signal adjustments are made based on device type information and other information received from the wireless power receiving devices and/or magnetic sensor readings from the magnetic sensors. In-phase or out-of-phase drive signals are applied to minimize ambient fields depending on device type.

Multiple wireless power receiving devices may be present on the charging surface. In this type of situation, the wireless power transmitting device transmits wireless power using sets of coils that are coupled to respective wireless power receiving devices while making adjustments to drive signal phase and magnitude for each coil to reduce ambient field emission.

### BRIEF DESCRIPTION OF THE DRAWINGS

FIG. 1 is a schematic diagram of an illustrative wireless charging system that includes a wireless power transmitting device and a wireless power receiving device in accordance with an embodiment.

FIG. 2 is a circuit diagram of illustrative wireless power transmitting circuitry and illustrative wireless power receiving circuitry in accordance with an embodiment.

FIG. 3 is a top view of an illustrative wireless power transmitting device on which a wireless power receiving device has been placed in accordance with an embodiment.

FIG. 4 is a top view of an illustrative wireless power transmitting coil in accordance with an embodiment.

FIG. 5 is a top view of an illustrative wireless power transmitting device with an array of coils in multiple layers in accordance with an embodiment.

FIG. 6 is a side view of an illustrative coil in accordance with an embodiment.

FIG. 7 is a perspective view of an illustrative wireless power transmitting coil in accordance with an embodiment.

FIG. 8 is a top view of an illustrative wireless power receiving coil in a wireless power receiving device and associated coils in a wireless power transmitting device in accordance with an embodiment.

FIG. 9 is a side view of an illustrative wireless power receiving coil in another wireless power receiving device and associated coils in a wireless power transmitting device in accordance with an embodiment.

FIG. 10 is a perspective view of an illustrative set of wireless power receiving devices on a wireless power transmitting device in accordance with an embodiment.

FIG. 11 is a graph of illustrative signals that may be used to drive coils in a wireless power transmitting device in accordance with an embodiment.

FIG. 12 is a cross-sectional side view of an illustrative wireless power transmitting coil and an associated supplemental non-wireless-power-transmitting coil for nulling ambient fields in accordance with an embodiment.

FIG. 13 is a top view of an illustrative wireless power transmitting device with supplemental coils and magnetic sensors in accordance with an embodiment.

FIG. 14 is a flow chart of illustrative operations involved in operating a wireless power system in accordance with an embodiment.

### DETAILED DESCRIPTION

A wireless power system has a wireless power transmitting device such as a wireless charging mat. The wireless power transmitting device wirelessly transmits power to a wireless power receiving device such as a wristwatch, cellular telephone, tablet computer, laptop computer, wireless headphone (earbuds) charging case, or other electronic device. The wireless power receiving device uses power from the wireless power transmitting device for powering the device and for charging an internal battery.

The wireless power transmitting device has an array of wireless power transmitting coils arranged in multiple layers under a charging surface. During operation, the wireless power transmitting coils are used to transmit wireless power signals that are received by a wireless power receiving coil in the wireless power receiving device. Each wireless power transmitting coil may be connected to a respective capacitor in a resonant circuit. Optional magnetic sensors and supplemental field-nulling coils may be included in the wireless power transmitting device. During operation, the signals to the coils in the transmitting device are adjusted to transmit power to wireless power receiving devices while reducing ambient magnetic fields.

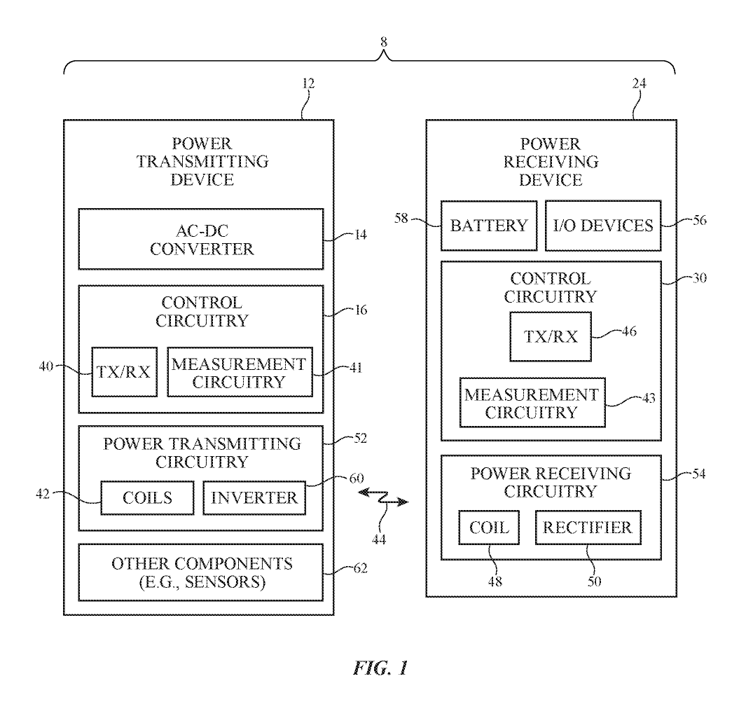

An illustrative wireless power system (wireless charging system) is shown in FIG. 1. As shown in FIG. 1, wireless power system 8 includes a wireless power transmitting device such as wireless power transmitting device 12 and includes a wireless power receiving device such as wireless power receiving device 24. Wireless power transmitting device 12 includes control circuitry 16. Wireless power receiving device 24 includes control circuitry 30. Control circuitry in system 8 such as control circuitry 16 and control circuitry 30 is used in controlling the operation of system 8. This control circuitry includes processing circuitry associated with microprocessors, power management units, baseband processors, digital signal processors, microcontrollers, and/or application-specific integrated circuits with processing circuits. The processing circuitry implements desired control and communications features in devices 12 and 24. For example, the processing circuitry may be used in determining power transmission levels, processing sensor data, processing user input, handling communications between devices 12 and 24 (e.g., sending and receiving in-band and out-of-band data), selecting wireless power transmitting coils, adjusting the phase and magnitude of drive signals supplied to selected coils, and otherwise controlling the operation of system 8.

Control circuitry in system 8 may be used to authorize components to use power and ensure that components do not exceed maximum allowable power consumption levels. Control circuitry in system 8 may be configured to perform operations in system 8 using hardware (e.g., dedicated hardware or circuitry), firmware and/or software. Software code for performing operations in system 8 is stored on non-transitory computer readable storage media (e.g., tangible computer readable storage media) in control circuitry 8. The software code may sometimes be referred to as software, data, program instructions, instructions, or code. The non-transitory computer readable storage media may include non-volatile memory such as non-volatile random-access memory (NVRAM), one or more storage drives (e.g., magnetic drives or solid state drives), one or more removable flash drives or other removable media, or the like. Software stored on the non-transitory computer readable storage media may be executed on the processing circuitry of control circuitry 16 and/or 30. The processing circuitry may include application-specific integrated circuits with processing circuitry, one or more microprocessors, a central processing unit (CPU) or other processing circuitry.

Power transmitting device 12 may be a stand-alone power adapter (e.g., a wireless charging mat that includes power adapter circuitry), may be a wireless charging mat that is connected to a power adapter or other equipment by a cable, may be a portable device, may be equipment that has been incorporated into furniture, a vehicle, or other system, or may be other wireless power transfer equipment. Illustrative configurations in which wireless power transmitting device 12 is a wireless charging mat may sometimes be described herein as an example.

Power receiving device 24 may be a portable electronic device such as a wristwatch, a cellular telephone, a laptop computer, a tablet computer, a case or enclosure (e.g., a wireless earbuds charging case), or other electronic equipment. Power transmitting device 12 may be connected to a wall outlet (e.g., alternating current), may have a battery for supplying power, and/or may have another source of power. Power transmitting device 12 may have an AC-DC power converter such as power converter 14 for converting AC power from a wall outlet or other power source into DC power. DC power may be used to power control circuitry 16. During operation, a controller in control circuitry 16 uses power transmitting circuitry 52 to transmit wireless power to power receiving circuitry 54 of device 24. Power transmitting circuitry 52 has switching circuitry (e.g., inverter circuitry 60 formed from transistors, sometimes referred to as inverter circuitry, power transmitting circuitry, and/or control circuitry) that is turned on and off based on control signals provided by control circuitry 16 to create AC current signals through one or more coils 42. Coils 42 may be arranged in a planar coil array (e.g., in configurations in which device 12 is a wireless charging mat). If desired, device 12 may contain supplemental coils (e.g., coils for helping to reduce stray magnetic fields) and/or other components 62 (e.g., magnetic sensors and/or other sensors, input-output devices, etc.).

As AC currents pass through one or more coils 42, alternating-current electromagnetic fields (signals 44) are produced that are received by one or more corresponding coils such as wireless power receiving coil 48 in power receiving device 24. When the alternating-current electromagnetic fields are received by coil 48, corresponding alternating-current currents are induced in coil 48. Rectifier circuitry such as rectifier 50, which contains rectifying components such as synchronous rectification metal-oxide-semiconductor transistors arranged in a bridge network, converts received AC signals (received alternating-current signals associated with electromagnetic signals 44) from coil 48 into DC voltage signals for powering device 24.

The DC voltages produced by rectifier 50 are used in charging a battery such as battery 58 and/or are used in powering other components in device 24. For example, device 24 may include input-output devices 56 such as a display, touch sensor, communications circuits, audio components, sensors, and other components and these components may be powered by the DC voltages produced by rectifier 50 (and/or DC voltages produced by battery 58).

Device 12 and/or device 24 communicate wirelessly using in-band and/or out-of-band communications. Device 12 may, for example, have wireless transceiver circuitry 40 that wirelessly transmits out-of-band signals to device 24 using an antenna. Wireless transceiver circuitry 40 may be used to wirelessly receive out-of-band signals from device 24 using the antenna. Device 24 may have wireless transceiver circuitry 46 that transmits out-of-band signals to device 12. Receiver circuitry in wireless transceiver 46 may use an antenna to receive out-of-band signals from device 12.

Wireless transceiver circuitry 40 uses one or more coils 42 to transmit in-band signals to wireless transceiver circuitry 46 that are received by wireless transceiver circuitry 46 using coil 48. Any suitable modulation scheme may be used to support in-band communications between device 12 and device 24. With one illustrative configuration, frequency-shift keying (FSK) is used to convey in-band data from device 12 to device 24 and amplitude-shift keying (ASK) is used to convey in-band data from device 24 to device 12. Power is conveyed wirelessly from device 12 to device 24 during these FSK and ASK transmissions.

During wireless power transmission operations, circuitry 52 supplies AC drive signals to one or more coils 42 at a given power transmission frequency. The power transmission frequency may be, for example, a predetermined frequency of about 125 kHz, at least 80 kHz, at least 100 kHz, less than 500 kHz, less than 300 kHz, 50-200 kHz, or other suitable wireless power frequency. In some configurations, the power transmission frequency may be negotiated in communications between devices 12 and 24. In other configurations, the power transmission frequency is fixed.

During wireless power transfer operations, while power transmitting circuitry 52 is driving AC signals into one or more of coils 42 to produce signals 44 at the power transmission frequency, wireless transceiver circuitry 40 uses FSK modulation to modulate the power transmission frequency of the driving AC signals and thereby modulate the frequency of signals 44. In device 24, coil 48 is used to receive signals 44. Power receiving circuitry 54 uses the received signals on coil 48 and rectifier 50 to produce DC power. At the same time, wireless transceiver circuitry 46 uses FSK demodulation to extract the transmitted in-band data from signals 44. This approach allows FSK data (e.g., FSK data packets) to be transmitted in-band from device 12 to device 24 with coils 42 and 48 while power is simultaneously being wirelessly conveyed from device 12 to device 24 using coils 42 and 48.

In-band communications between device 24 and device 12 uses ASK modulation and demodulation techniques or other amplitude-based modulation and demodulation techniques. Wireless transceiver circuitry 46 transmits in-band data to device 12 by using a switch (e.g., one or more transistors in transceiver 46 that are connected to coil 48) to modulate the impedance of power receiving circuitry 54 (e.g., coil 48). This, in turn, modulates the amplitude of signal 44 and the amplitude of the AC signal passing through coil(s) 42. Wireless transceiver circuitry 40 monitors the amplitude of the AC signal passing through coil(s) 42 and, using ASK demodulation, extracts the transmitted in-band data from these signals that was transmitted by wireless transceiver circuitry 46. The use of ASK communications allows ASK data bits (e.g., ASK data packets) to be transmitted in-band from device 24 to device 12 with coils 48 and 42 while power is simultaneously being wirelessly conveyed from device 12 to device 24 using coils 42 and 48.

Control circuitry 16 has external object measurement circuitry 41 (sometimes referred to as foreign object detection circuitry or external object detection circuitry) that detects external objects on a charging surface associated with device 12. Circuitry 41 can detect foreign objects such as coils, paper clips, and other metallic objects and can detect the presence of wireless power receiving devices 24. Control circuitry 30 has measurement circuitry 43. Measurement circuitry 41 and 43 may be used in making impedance measurements such as inductance measurements (e.g., measurements of the inductances of coils 42 and 48), input and output voltage measurements (e.g., a rectifier output voltage, and inverter input voltage, etc.), current measurements, capacitance measurements, impedance measurements and other measurements that are indicative of coupling between coils 42 and coils 48, and/or other measurements on the circuitry of system 8.

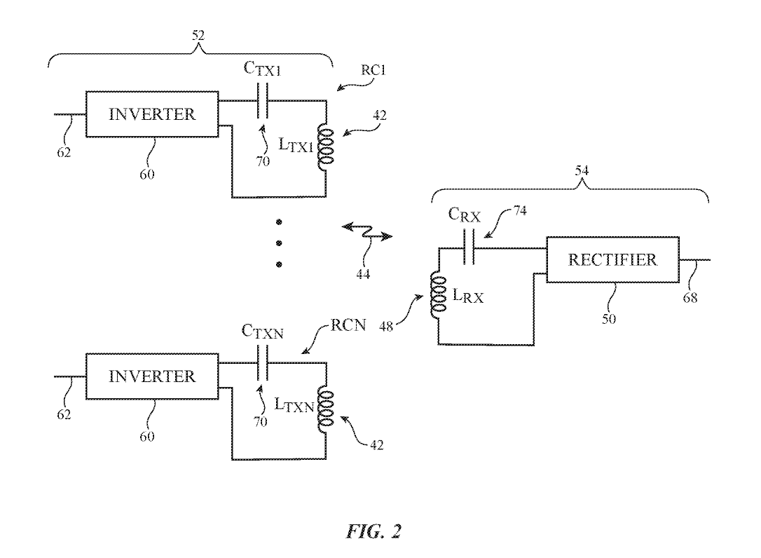

Illustrative circuitry of the type that may be used for forming power transmitting circuitry 52 and power receiving circuitry 54 of FIG. 1 is shown in FIG. 2.

As shown in FIG. 2, power transmitting circuitry 52 may include drive circuitry such as inverters 60 coupled to respective resonant circuits RC1 . . . RCN. Each resonant circuit may include a wireless power transmitting coil 42 and capacitor 70. In resonant circuits RC1 . . . RCN, coils 42 may have respective inductances Ltx1 . . . Ltxn and capacitors 70 may have respective capacitances Ctx1 . . . Ctxn. Coils 42 may all have a common shape or may have different shapes. The values of Ltx1 . . . Ltxn may all be the same or the values of Ltx1 . . . Ltxn may differ due to differing distances to coil 48 of device 24, etc. Capacitors Ctx1 . . . Ctxn may have values selected to promote uniformity across device 10 and/or may share a common value. In some configurations, the resonant circuit capacitors in device 12 have different values in different layers of coils 42.

Inverters 60 have metal-oxide-semiconductor transistors or other suitable transistors that are modulated by AC control signals from control circuitry 16 (FIG. 1) that are received on respective control signal inputs 62. The attributes of each AC control signal (e.g., duty cycle, phase, magnitude, and/or other attributes) are adjusted dynamically during power transmission to control the amount of power being transmitted by power transmitting coils 42 and to help minimize ambient magnetic fields (e.g., to help reduce magnetic fields at a given distance from device 12 such as a distance of 10 m or other suitable distance). The minimization of ambient magnetic fields produced by device 12 helps ensure that regulatory limits for emitted magnetic field strength are satisfied.

When transmitting wireless power, control circuitry 16 (FIG. 1) selects one or more appropriate coils 42 to use in transmitting signals 44 to coil 48 (e.g., control circuitry 16 supplies control signals to the inputs 62 of the inverters 60 connected to the selected coils to produce signals 44 and otherwise adjusts the operation of the resonant circuits in circuitry 52). Coil 48 and capacitor 74 (of capacitance Crx) form a resonant circuit in circuitry 54 that receives signals 44. Receiver 50 rectifies the received signals and provides direct-current output power at output 68.

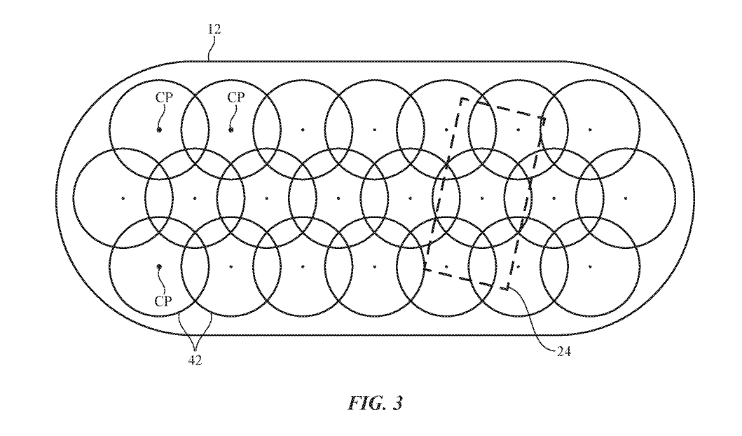

A top view of an illustrative configuration for device 12 in which device 12 has an array of coils 42 is shown in FIG. 3. Device 12 may, in general, have any suitable number of coils 42 (e.g., 22 coils, at least 5 coils, at least 10 coils, at least 15 coils, fewer than 30 coils, fewer than 50 coils, etc.). Coils 42 may be arranged in rows and columns and may or may not partially overlap each other. Device 12 may have a planar housing surface that covers coils 42 (sometimes referred to as a charging surface). One or more wireless power receiving devices such as device 24 may be positioned on the charging surface as shown in FIG. 3 to receive wireless power from coils 42. Coils 42 may be circular or may have other suitable shapes (e.g., coils 42 may be square, may have hexagonal shapes, may have other shapes having rotational symmetry, etc.). In the illustrative configuration of FIG. 3, coils 42 are circular and are formed from multiple wire turns (e.g., multiple turns formed from metal traces, bare wire, insulated wire, wire monofilaments, multifilament wire, etc.) surrounding respective coil centers CP.

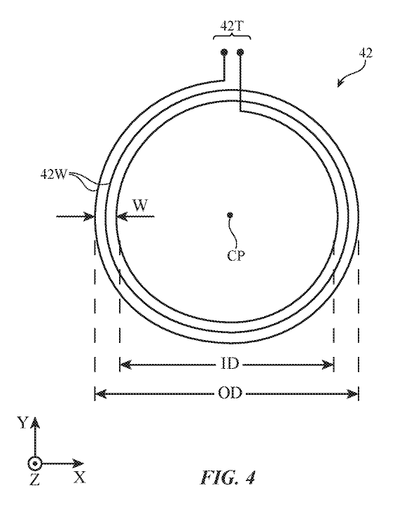

As shown in FIG. 4, each coil 42 may be characterized by a number of circular turns (wire loops) of wire 42W about coil center CP (e.g., 10-200 turns, fewer than 300 turns, fewer than 100 turns, at least 5 turns, at least 25 turns, or other suitable number of turns). Coils 42 may be characterized by an inner diameter ID, outer diameter OD, and wire turn width W. Each coil 42 has a pair of terminals 42T. Terminals 42T for different coils 42 may share the same angular orientation (angle) relative to coil center CP and/or may have different angular orientations. Coils 42 may be organized in multiple layers and may include coils that overlap each other (e.g., coils in one layer that overlap coils in one or more other layers).

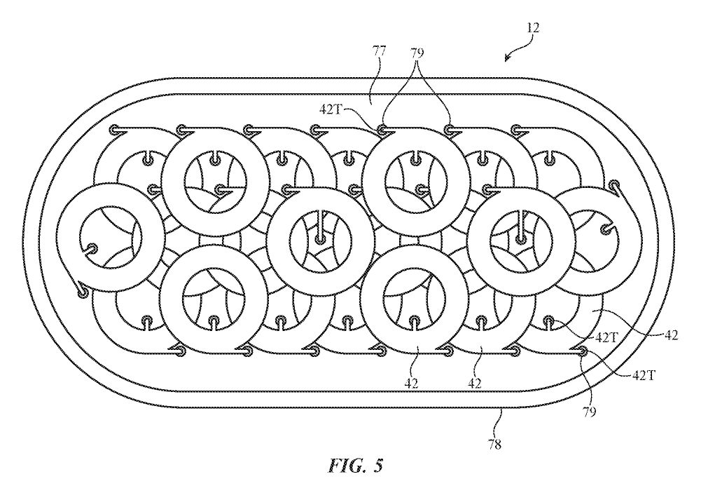

As shown in FIG. 5, device 12 may have a housing 78 (e.g., a housing formed from plastic or other materials with a planar upper surface that forms a charging surface) that encloses multiple layers of coils 42. In the illustrative example of FIG. 5, device 12 has three layers of coils 42. Configurations with different numbers of coil layers may also be used. Coils 42 may be mounted above a printed circuit board 77 having openings 79 that accommodate terminal wires in terminals 42T.

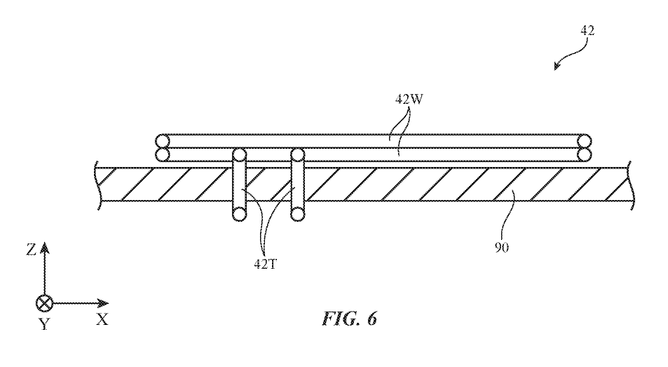

A cross-sectional side view of an illustrative coil is shown in FIG. 6. As shown in FIG. 6, coil 42 has multiple turns of wire 42W that lie above a layer of magnetic material such as ferrite layer 90. Terminals 42T are formed from lengths of wire that run vertically (parallel to the Z axis) through openings in a magnetic shielding layer such as ferrite layer 90 (e.g., a layer interposed between printed circuit board 77 if FIG. 5 and coils 42). The presence of terminals 42T forms a loop of current during wireless power transmission operations. This loop of current produces lateral (radially extending) magnetic fields (fields in the X-Y plane). To ensure that these magnetic fields are sufficiently small (e.g., to ensure that regulatory limits on emitted magnetic field strength are satisfied), the placement of coils 42 on surface 12C is adjusted, supplemental coils are switched into use to produce cancelling magnetic fields, and/or the phase and/or magnitude of the drive signals supplied to coils 42 are adjusted. Adjustments can be made based on which coils 42 are coupled to coil(s) 48, based on magnetic sensor measurements, based on information on the type of device 24 that is present, based on the number of devices 24 that are being charged, and/or other information. Control circuitry 16 can use look-up tables and/or other arrangements to determine appropriate drive signals to use when transmitting wireless power with coils 42. By adjusting the operating settings of device 12 appropriately (e.g., by adjusting phase, magnitude, and/or other drive signal attributes during operation, by switching supplemental coils into use, etc.), magnetic field strength surrounding device 12 can be reduced. In some embodiments, receiving device 24 (e.g., coil 48) overlaps a first coil 42 (or first set of coils 42) and, in response to placement of device 24 on device 12 in this position, control circuitry 16 uses power transmitting circuitry 52 to energize at least a second coil 42 (or second set of coils) that is not overlapped by coil 48 to reduce ambient magnetic fields.

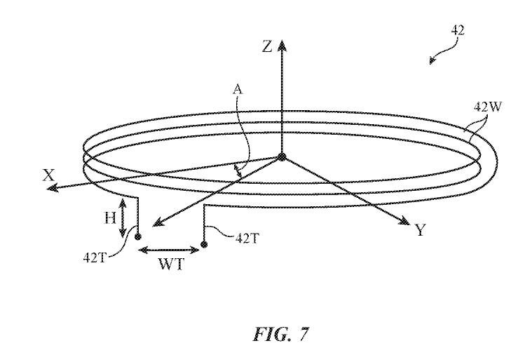

FIG. 7 shows how terminals 42T in each coil 42 have an angular orientation (angle A with a value of 0-360°) with respect to the X axis. The wires forming terminals 42T are characterized by a length (height H) and are spaced apart by a width WT. Coil terminal characteristics such as angular orientation A and/or terminal shape and size (e.g., height H and/or width WT) can be adjusted to adjust lateral magnetic field strength. If desired, for example, the terminals 42T in one coil may be placed in a direction that opposes the terminals 42T in another coil, so that the magnetic fields that are produced by these coils have an opportunity to cancel one another when the coils are both being supplied with drive current. In some configurations, terminals 42T for different coils 42 share a common angular orientation.

Drive signal adjustments also reduce ambient magnetic fields (e.g., magnetic fields measured at a distance of 1-50 m from device 12, at a distance of at least 0.5 m from device 12, at a distance of 10 m from device 12, etc.). In some configurations, the type of drive signal adjustments that control circuitry 16 makes to reduce magnetic field emissions in the vicinity of device 12 (sometimes referred to as ambient magnetic fields) varies as a function of device type.

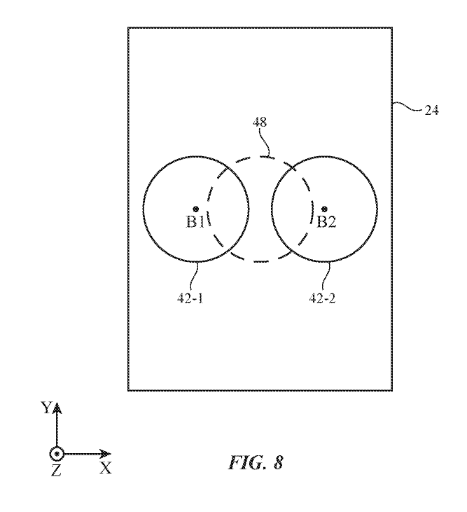

As a first example, a device such as a cellular telephone is charged. This type of device has a planar housing and a coil that lies in the plane of the housing. Cellular telephones therefore lie flat on the charging surface of device 12. In this arrangement, coil 48 in the cellular telephone (receiving device 24) overlaps and is magnetically coupled to one or more coils 42 as shown in FIG. 8. In the example of FIG. 8, first coil 42-1 and second coil 42-2 are each magnetically coupled to coil 48 and can therefore be used to produce magnetic fields (fields B1 and B2, respectively) for supplying wireless power to device 24. To minimize ambient magnetic fields in this type of arrangement, it may be desirable to drive coils 42-1 and 42-2 (and, if desired, any additional coils overlapping coil 48) in phase (e.g., with drive signals that have phases within 2° of each other, within 5° of each other, within 10° of each other, or within other suitable small phase shift value). With in-phase drive signals applied to coils 42-1 and 42-2 of FIG. 8, magnetic fields B1 and B2 are in phase and pass vertically through coil 48 before returning to coils 42-1 and 42-2. This helps reduce ambient fields such as lateral ambient fields.

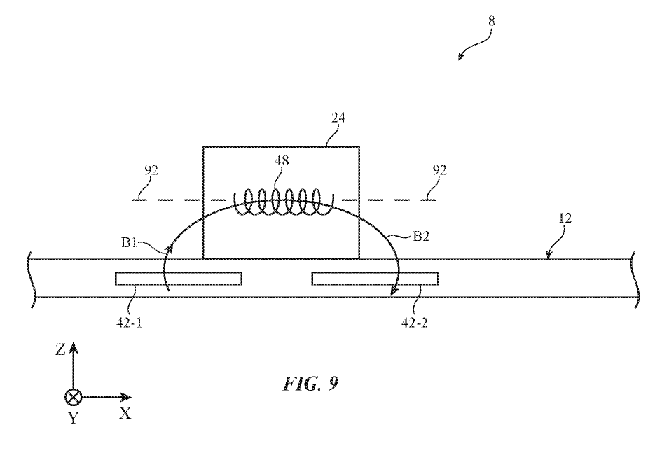

A second example is illustrated in FIG. 9. In the scenario of FIG. 9, receiving device 24 is a wristwatch device lying on its side on the charging surface of device 12. Device 24 has one or more coils such as a coil 48 with the shape of a solenoid (e.g., a coil having an elongated coil shape with a solenoid axis 92 that lies in the X-Y plane when device 24 is lying on its side). In this configuration, lateral ambient fields are reduced by driving coils 42-1 and 42-2 out of phase (e.g., field B1 from coil 42-1 and field B2 from coil 42-1 may be 180° out of phase with respect to each other within 2°, 5°, 10°, or other small phase shift). By driving coils 42-1 and 43-2 with drive signals of opposing phase, magnetic fields can be efficiently coupled into coil 48 and ambient fields such as lateral ambient fields can be reduced. Similarly, in scenarios in which device 24 of FIG. 9 overlaps three or more coils 42, the phases of the overlapping three or more coils 42 can be adjusted to enhance coupling with a laterally oriented coil 48.

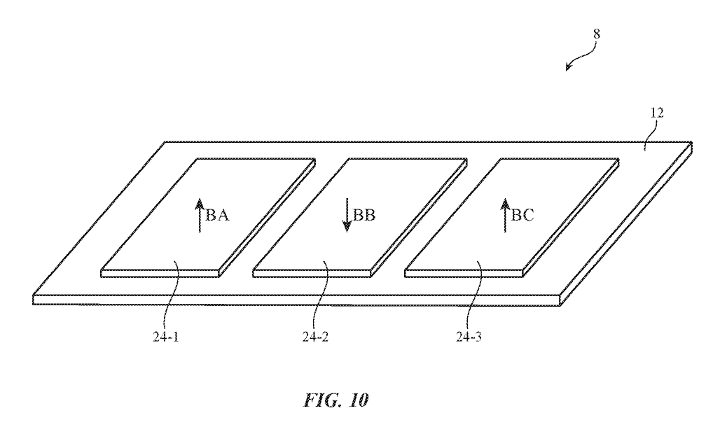

In some situations, multiple wireless power receiving devices 24 overlap the coils of device 12. Consider, as an example, the scenario of FIG. 10. In this scenario, a first power receiving device 24-1 overlaps a first set of one or more coils 42 in device 12, a second power receiving device 24-2 overlaps a second set of one or more different coils 42 in device 12, and a third power receiving device 24-3 overlaps a third set of one or more different coils 42 in device 12.

Within each set of overlapped coils, lateral ambient fields can be reduced by out-of-phase or in-phase coil drive signals as described in connection with the examples of FIGS. 8 and 9. For example, in the scenario of FIG. 10, the first set of coils may be driven in phase with respect to each other, the second set of coils may be driven in phase with respect to each other, and the third set of coils may be driven in phase with respect to each other. This helps reduce lateral field emission from each of the power receiving devices.

To further reduce the overall ambient field emissions from system 8, control circuitry 16 adjusts the relative phases of the drive signals used respectively in driving the first, second, and third sets of coils. As shown in FIG. 10, for example, field BA and field BC may be produced in phase with each other by driving the first and third sets of coils 42 of device 12 in phase with respect to each other (e.g., within 2°, 5°, 10°, or other small phase shift). Device 24-2 is located between devices 24-1 and 24-3 on the charging surface of device 12 and can be driven with an out-of-phase signal with respect to the signals for the first and third sets. In particular, the second set of coils in device 12 that are coupled with the coil 48 of device 24-2 may be driven 180° out-of-phase with respect to the signals used in driving the first and third sets of coils (e.g., within 2°, 5°, 10°, or other phase shift). By driving the coils overlapped by the centermost device 24 out of phase with respect to the outer devices 24, lateral ambient fields are reduced.

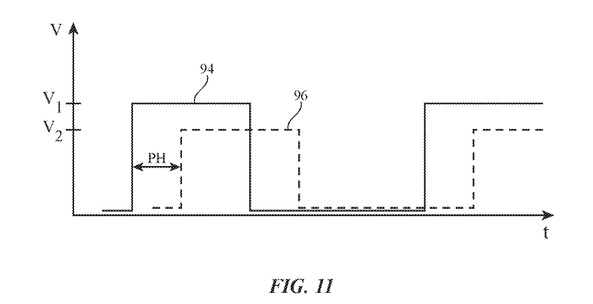

If desired, control circuitry 16 can make drive signal magnitude adjustments in addition to or instead of making drive signal phase adjustments. An illustrative set of drive signals V of the type that are applied to coils 42 by control and inverter circuitry in device 12 are shown in the graph of FIG. 11. In the example of FIG. 11, two drive signals have been produced: drive signal 94 and drive signal 96. As shown in FIG. 11, drive signal 94 may be characterized by a magnitude V1 and a phase. Drive signal 96 may be characterized by a different magnitude V2 and a different phase (e.g., a phase resulting in a phase difference PH between signals 94 and 96). In general, drive signal shape, drive signal duty cycle, drive signal phase, and/or drive signal magnitude or other attributes may be adjusted by control circuitry 16 to help reduce ambient fields. Drive signals for coils 4 may be square waves or signals with other suitable alternating-current shapes.

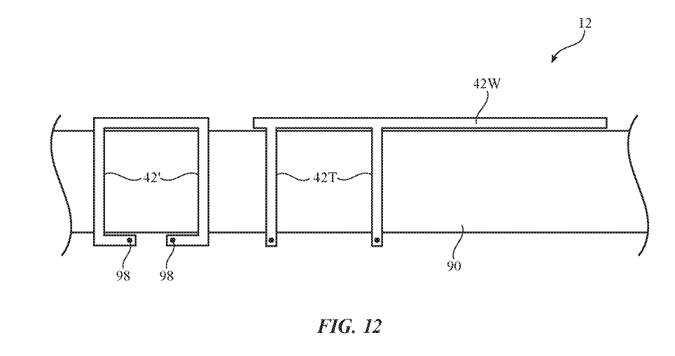

FIG. 12 shows how supplemental coil structures (coil 42′) may be provided in device 12 (e.g., coils formed from wire loops passing through openings in magnetic layer 90). When current is applied to these supplemental coils (e.g., when current is applied to coil 42′ at terminals 98 by control circuitry 16 using an inverter), lateral magnetic fields and other magnetic fields are produced that help cancel unwanted lateral magnetic fields and thereby reduce ambient field strength. Regular coils 42 have loops of wire 42W for transmitting wireless power. Coils 42′, which are sometimes referred to as non-power-transmitting coils or ambient magnetic field reduction coils, may or may not be used in transferring wireless power to device 24. In one illustrative configuration, coils 42′ are non-power-transmitting coils that do not have any coil wires 42W in the X-Y plane of FIG. 12 and therefore do not transmit power for device 24 (e.g., less than 1% or less than 0.1% of wireless power in device 12 is transmitted using the non-power-transmitting coils).

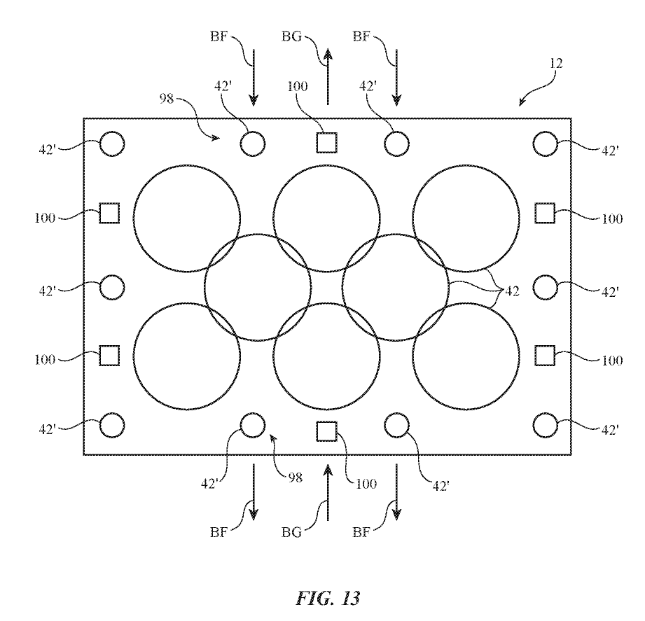

To monitor for the presence of undesired lateral magnetic fields that could result in excess ambient field strength, device 12 optionally has one or more magnetic sensors 100. As shown in FIG. 13, there may be one or more sensors 100 located around the periphery of device 12 or elsewhere in device 12. Control circuitry 16 can use magnetic field strength measurements from one or more of sensors 100 in adjusting signals applied to the coils of device 12 to reduce ambient magnetic fields. Magnetic field strength can also be measured using external test equipment during manufacturing. During manufacturing calibration operations, settings are identified for the drive signals for coils 42 in different operating scenarios that help to reduce ambient fields.

Consider, as an example, a scenario in which receiving device 24 overlaps coils 42 in the center of device 12. In this scenario, a lateral magnetic field BG may be emitted by device 12. To help suppress field BG, coils 42 and/or supplemental coils 42′ may be driven to produce cancelling field BF while allowing wireless power to be transmitted from coils 42 to coil 48 in device 24.

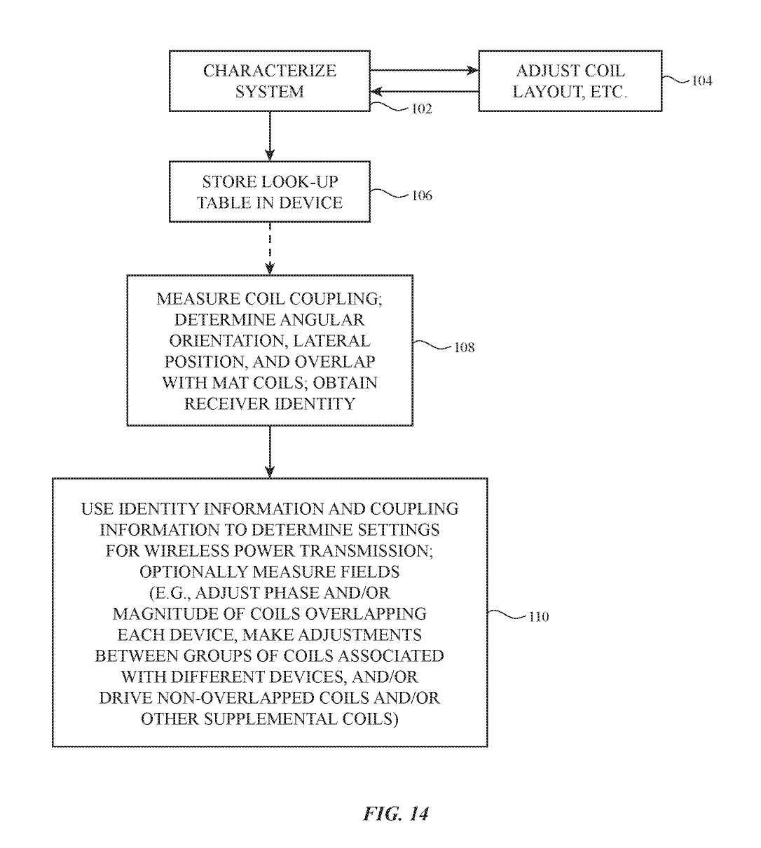

Illustrative operations involved in transferring power wirelessly from device 12 to one or more devices 24 in system 8 are shown in FIG. 14.

During the operations of block 102, system 8 is characterized. Magnetic sensors in test equipment and/or optional magnetic sensors 100 gather magnetic field measurements during a series of illustrative operating scenarios. Different types of wireless power receiving devices (cellular telephones, tablet computers, wrist watches, ear buds, wireless headphone cases, and other electronic devices) are placed in a series of different locations such as various X-Y positions and/or angular orientations across the charging surface of device 12. Wireless power is transmitted from a series of different combinations of coil(s) 42 using drive signals of different phases and/or magnitudes while optional supplemental coils(s) 42′ are driven using drive signals of different phases and/or magnitudes. By characterizing the magnetic fields produced when transferring power in system 8 as a function of device type, device angular orientation, device lateral position, the number of devices being charged, the presence and/or absence of supplemental coils 42′ and associated supplemental coil drive signal strengths, and/or the values of magnetic fields measured using magnetic sensors 100, an appropriate response (drive signal adjustments for coils 42 and/or 42′) to each possible operating scenario is produced.

In some manufacturing characterization scenarios, physical adjustments are made to the configurations of coils 42 and/or 42′ (e.g., the angular orientation A of terminals 42T in coils 42, the values of terminal wire height H and width WT, and/or other coil attributes such as lateral position, overlap or coil coupling as measured by measurement circuitry 41 and/or 43, size, etc.). These adjustments can be characterized using software modelling and/or external test equipment magnetic field measurements during design and manufacturing operations to identify configurations with reduced ambient fields (see, e.g., block 104).

Characterization information gathered during block 102 is stored in a look-up table or other data structure in device 12 during the operations of block 106. The characterization information identifies, for each characterized parameter (e.g., each device type, angular orientation, coil coupling value, wireless power transmission level, lateral position, magnetic sensor measurement, drive signal phase and magnitude, etc.), corresponding operating settings for device 12 (e.g., drive current magnitude and phase for each coil 42 and each optional supplemental coil 42′).

After characterization and calibration operations (blocks 102, 104, and 106) are complete, device 12 is used in charging one or more devices 24 in system 8.

During the operations of block 108, for example, coil coupling is measured between each coil 42 in device 12 and each power receiving device coil 48 in the device(s) 24 that is present on the charging surface of device 12. Coil coupling is measured using measurement circuits such as circuits 41 and/or 43 and/or other circuitry in system 8. Coil coupling measurements and/or other measurements made with circuitry 41 and/or 43 indicate where each power receiving device and its coil(s) 48 is located on device 12. Information on which types of power receiving devices 24 are present and desired power transmission levels for each device is obtained using wireless communications. For example, each device 24 can send a receiver identifier or other information indicative of device type such as cellular telephone, watch, wireless headphone case, etc. and/or power level adjustment commands and/or other information indicative of desired power transmission settings to device 12 using in-band and/or out-of-band communications. In some configurations, device type information is obtained by processing measurements from measurement circuitry 41 (e.g., patterns of measured impedance changes for coils 42 across the charging surface, etc.).

The information obtained during the operations of block 108 and the characterization information stored in the look-up table or other data structure of block 106 are used during the operations of block 110. In particular, control circuitry uses information on device type and/or other wireless power receiving device information, impedance measurements and other measurements made with circuitry 41 and/or circuitry 43 such as coil coupling measurements indicating how strongly each coil in device 12 is coupled to each device 24 and therefore the position of each device 24 on the charging surface of device 12, information on desired power transmission levels, information on measured magnetic fields (e.g., real time magnetic field measurements made using one or more magnetic sensors 100), and/or other information on the operating environment of system 8 in making appropriate selections for the phase, magnitude, and other attributes of the drive signals applied to the coils in device 12. For example, when a receiving device such as a cellular telephone is coupled to multiple coils 42, the coils 42 may be driven in phase as described in connection with FIG. 8. When multiple devices 24 (e.g., cellular telephones) overlap multiple respective sets of coils 42, the coils 42 in each set may be driven appropriately (e.g., in phase) to reduce ambient fields and the sets of coils may each be provided with appropriate signals (e.g., some of the sets may be driven in phase with each other and some of the sets may be driven out of phase with each other). In configurations with non-power-transmitting coils, drive signal phase and magnitude for coils 42 and the attributes of the drive signals applied to the non-power coils 42′ are adjusted to reduce ambient magnetic fields.

The foregoing is merely illustrative and various modifications can be made to the described embodiments. The foregoing embodiments may be implemented individually or in any combination.

What is claimed is:

1. A wireless power transmitting device configured to transmit wireless power to a wireless power receiving device through a charging surface, comprising:
wireless power transmitting coils; and
control circuitry coupled to the wireless power transmitting coils that is configured to reduce ambient magnetic fields while transmitting the wireless power based at least partly on information associated with the wireless power receiving device.

2. The wireless power transmitting device of claim 1 wherein the control circuitry comprises measurement circuitry configured to measure the information associated with the wireless power receiving device.

3. The wireless power transmitting device of claim 2 wherein the measurement circuitry is configured to measure magnetic coupling between at least two of the wireless power transmitting coils and the wireless power receiving device and wherein the control circuitry is configured to reduce the ambient magnetic fields while transmitting the wireless power while by generating drive signals for the at least two wireless power transmitting coils based at least partly on the measured magnetic coupling.

4. The wireless power transmitting device of claim 3 wherein the control circuitry is configured to receive information from the wireless power receiving device via a power transmitting coil that provides wireless power to the wireless power receiving device.

5. The wireless power transmitting device of claim 4 wherein the control circuitry is configured to reduce the ambient magnetic fields by transmitting the wireless power by generating drive signals for the wireless power transmitting coils based at least partly on the information received from the wireless power receiving device.

6. The wireless power transmitting device of claim 5 wherein the information received from the wireless power receiving device comprises device type information.

7. The wireless power transmitting device of claim 5 wherein the information received from the wireless power receiving device comprises device type information selected from the group consisting of: a cellular telephone device type, a wristwatch device type, and a wireless headphone charging case type.

8. The wireless power transmitting device of claim 3 wherein the wireless charging surface is configured to receive first, second, and third wireless power receiving devices, wherein the wireless power receiving device is one of the first, second, and third wireless power receiving devices, wherein the control circuitry is configured to supply first drive signals to a first set of one or more of the wireless power transmitting coils that are magnetically coupled to the first wireless power receiving device, to supply second drive signals to a second set of one or more of the wireless power transmitting coils that are magnetically coupled to the second wireless power receiving device, and to supply third drive signals to a third set of one or more of the wireless power transmitting coils that are magnetically coupled to the third wireless power receiving device, and wherein the drive signals applied to the first set of wireless power transmitting coils are out of phase with the drive signals applied to the second set of wireless power transmitting coils.

9. The wireless power transmitting device of claim 8 wherein the drive signals applied to the third set of wireless power transmitting coils are in phase with the drive signals applied to the first set of wireless power transmitting coils.

10. The wireless power transmitting device of claim 9 wherein the first set of wireless power transmitting coils includes multiple wireless power transmitting coils each of which is driven in phase by the drive signals applied to the first set of wireless power transmitting coils.

11. The wireless power transmitting device of claim 1 further comprising:
a magnetic layer, wherein the wireless power transmitting coils each have terminals that pass through the magnetic layer; and
ambient magnetic field reduction coils formed from wires passing through the magnetic layer that are configured to reduce ambient magnetic fields resulting from wireless power transmission using the wireless power transmitting coils.

12. The wireless power transmitting device of claim 1 further comprising non-ambient magnetic field reduction coils, wherein the control circuitry is configured to apply signals to the ambient magnetic field reduction coils to reduce the ambient magnetic fields while transmitting the wireless power using the wireless power transmitting coils.

13. The wireless power transmitting device of claim 1 further comprising a magnetic sensor configured to measure a magnetic field, wherein the control circuitry is configured to apply signals to the wireless power transmitting coils at least partly based on the measured magnetic field.

14. The wireless power transmitting device of claim 1, wherein the information comprises device identifier information received wirelessly from the wireless power receiving device and wherein the control circuitry is configured to apply signals to the wireless power transmitting coils at least partly based on the device identifier information received wirelessly from the wireless power receiving device.

15. The wireless power transmitting device of claim 2 further comprising a housing configured to form a wireless charging mat, wherein the wireless power transmitting coils are arranged in the housing.

16. The wireless power transmitting device of claim 15 wherein the housing includes at least 5 and fewer than 30 of the wireless power transmitting coils and wherein at least two of the wireless power transmitting coils overlap each other.

17. The wireless power transmitting device of claim 15 wherein the wireless power receiving device includes a wireless power receiving coil and wherein the control circuitry is configured to:
in response to placement of the wireless power receiving device on the charging mat in a position where the wireless power receiving coil overlaps a first of the wireless power transmitting coils, energize at least a second of the wireless power transmitting coils that is not overlapped by the wireless power receiving coil to reduce the ambient magnetic fields while transmitting the wireless power.

18. A wireless power transmitting device configured to transmit wireless power to a wireless power receiving device through a charging surface, comprising:
wireless power transmitting coils; and
control circuitry coupled to the wireless power transmitting coils including first and second wireless power transmitting coils that are magnetically coupled to the wireless power receiving device, wherein the control circuitry is configured to reduce ambient magnetic fields while transmitting the wireless power using at least the first and second wireless power transmitting coils.

19. The wireless power transmitting device of claim 18 wherein the control circuitry is configured to receive device identifier information from the wireless power receiving device and is configured to apply drive signals to the first and second coils to reduce the ambient magnetic fields based at least partly on the received device identifier information.

20. The wireless power transmitting device of claim 19 wherein the control circuitry is configured to apply in-phase drive signals to the first and second coils based on the received device identifier information.

21. The wireless power transmitting device of claim 19 wherein the control circuitry is configured to apply out-of-phase drive signals to the first and second coils based on the received device identifier information.

22. The wireless power transmitting device of claim 18 further comprising a housing configured to form a wireless charging mat, wherein the wireless power transmitting coils are located in the housing.

23. The wireless power transmitting device of claim 22 wherein at least two of the wireless power transmitting coils overlap each other and wherein the housing includes at least 5 and fewer than 30 of the wireless power transmitting coils.

24. The wireless power transmitting device of claim 22 wherein the wireless power receiving device includes a wireless power receiving coil and wherein the control circuitry is configured to:
in response to placement of the wireless power transmitting device on the charging mat in a position where the wireless power receiving coil overlaps the first and second wireless power transmitting coils, energize at least a third of the wireless power transmitting coils that is not overlapped by the wireless power receiving coil to reduce the ambient magnetic fields while transmitting the wireless power.

25. A wireless power transmitting device configured to transmit wireless power to at least first and second wireless power receiving devices through a charging surface, comprising:
wireless power transmitting coils including a first set of one or more wireless power transmitting coils magnetically coupled to the first wireless power receiving device and a second set of one or more wireless power transmitting coils magnetically coupled to the second wireless power receiving device; and
control circuitry configured to reduce ambient magnetic fields while transmitting the wireless power by adjusting drive signals to the first and second sets of wireless power transmitting coils.

26. The wireless power transmitting device of claim 25 wherein the control circuitry is configured to receive information from the first and second wireless power receiving devices and is configured to adjust drive signal phase and magnitude for the drive signals based at least partly on the received information to reduce the ambient magnetic fields while transmitting the wireless power.

27. The wireless power transmitting device of claim 26 wherein the first set of coils includes first and second wireless power transmitting coils and wherein the control circuitry is configured to drive the first and second wireless power transmitting coils out of phase to reduce the ambient magnetic fields.

28. The wireless power transmitting device of claim 27 wherein the second set of coils includes third and fourth wireless power transmitting coils and wherein the control circuitry is configured to drive the third and fourth wireless power coils in phase to reduce the ambient magnetic fields.

29. The wireless power transmitting device of claim 25 further comprising a housing configured to form a wireless charging mat, wherein the wireless power transmitting coils are located in the housing and wherein the wireless power transmitting coils partially overlap each other.
